(19) United States
(12) Patent Application Publication
(10) Pub. No.: US 2014/0026481 A1
(43) Pub. Date: Jan. 30, 2014

(54) LIQUID FOAM PRODUCTION METHOD AND APPARATUS

(71) Applicant: Karl Podmajersky, Currumbin (AU)

(72) Inventor: Karl Podmajersky, Currumbin (AU)

(21) Appl. No.: 14/003,148

(22) PCT Filed: Mar. 5, 2012
(86) PCT No.: PCT/AU2012/000224

§ 371 Date: Oct. 9, 2013

(30) Foreign Application Priority Data
Mar. 4, 2011 (AU) 2011900768

(51) Int. Cl. B01F 3/04; A01G 31/02

(52) U.S. Cl. CPC B01F 3/04446; A01G 31/02
USPC 47/62 N; 261/74

(57) ABSTRACT

This invention relates to a method and apparatus for producing liquid foam wherein the liquid foam is used to facilitate the delivery of nutrients to plants. The method and apparatus comprises a foam production unit (1) comprising a chamber (5), inlet means (8,9) to said chamber (5) for oxygenated air and liquid, and means for controlling the flow of said oxygenated air and liquid through or from said chamber (5) to thereby create a liquid foam.

### TECHNICAL FIELD

This invention relates to a method and apparatus for producing liquid foam. The present invention in a further aspect relates to a method and apparatus for growing plants and in particular to a method and apparatus which uses liquid foam to facilitate the delivery of nutrients to plants.

### BACKGROUND ART

Oxygenated air foam is used in a range of applications including in applications for fighting fires where water is scarce. Different types of injectors are used for producing the foam however each type of injector that is known has disadvantages.

Many different methods and apparatus are used for growing plants including methods and apparatus which use conventional growing media such as soil or other solid growing medium. Other methods and apparatus which are available use water for a growing medium such as methods and apparatus which use hydroponic and other techniques. In such methods, plants are grown with their roots submerged in a water based solution containing nutrients. Hydroponic systems may also be used with an inert medium such as gravel or pebbles. The advantage of hydroponic systems is that nutrients can be readily absorbed by the roots of plants rather than relying on nutrients contained in soil or the like and nutrient absorption can be enhanced by changing the polarity of the nutrients.

The advantages of hydroponic growing systems in addition to their being no soil required are that the water used in such systems can be recirculated which therefore results in lower water costs. In addition, nutrient supply and content in the water can be accurately controlled which results in lower nutrient costs. Yields are usually relatively high. Furthermore such systems are relatively compact making the care of plants easier as well as pest and disease control.

One disadvantage however is that it is possible the presence of nutrients and high humidity will stimulate bacteria growth such as growth of salmonella. High moisture levels can also result in plants being covered trays. Growing in this environment exposes the sprouted seed to dust and mould. Some moulds can be toxic and therefore growing of seed in this type of environment is not desirable. Seed can also be sprouted in hydroponic installations however often seed in these installations is also subject to bacteriological growth such as mould. Furthermore, whilst water can be recirculated, it is often necessary to top up the water supply as water can be lost through evaporation.

It would be desirable if a means and method were available which addressed one or more of the above disadvantages associated with the production of foam and hydroponic growing of plants.

### SUMMARY OF THE INVENTION

The present invention thus provides in a first preferred aspect, a foam production unit comprising a chamber, inlet means to said chamber for oxygenated air and liquid, and means for controlling the flow of said air and liquid through or from said chamber to thereby create a liquid foam. By controlling the flow of air and liquid through or from the chamber, a back pressure is created resulting in aeration of the liquid and creation of the liquid foam.

In one form the chamber of the foam production unit comprises a mixing chamber in which liquid and air supplied to the chamber are mixed. The inlet means may comprise one or more inlets for air and one or more inlets for liquid.

The chamber may have one or more outlets and the means may be provided for controlling or restricting flow from the one or more inlets of air and liquid to or through the one or more outlets. The means for controlling flow may comprise means in the chamber which provide a controlled directional path for air and liquid from the air and liquid inlet means to the outlet. The means for controlling or restricting flow may comprise a plurality of discrete elements within the chamber. The discrete elements may comprise a plurality of spherical members or members of any other shape. The discrete elements may substantially fill the mixing chamber or may only partially fill the chamber. The discrete elements may be free for movement in the chamber so as to mix liquid and air in the chamber to enhance liquid foam production.

In another embodiment, the controlling means within the chamber may comprise an organic or other solid permeable material. The permeable material may comprise a solid foam. The solid foam may be a flexible open cell solid foam such as an organic or other foam. For example the foam may be a plastics foam or urethane foam. Alternatively the permeable material may be any other organic or inorganic material such as fibrous material which has similar flow controlling or restricting properties to foam.

The one or more outlets form the chamber may comprise one or more openings or slots in a wall of the chamber.

In another aspect, the outlet or outlets from the chamber may be limited such that air and liquid mixed in said chamber can exit from said chamber through the outlet as liquid foam.

Preferably the outlet or outlets is/are defined by or comprises a permeable material or member. The permeable material may comprise a solid foam. The foam may be a flexible open cell solid foam such as an organic or other foam. The permeable material may be selectively compressed to vary its permeability and thus the foam production. Alternatively the outlet or outlets may comprise a permeable member or wall for example a member or wall having a plurality of fine perforations.

In one preferred form, the mixing chamber may be defined by an outer elongated housing or tube. Preferably at least one air supply tube extends into the mixing chamber for supply of air thereto. Preferably the air supply comprises an oxygenated air supply. At least one liquid supply tube may also extend into the mixing chamber for supply of liquid thereto. The air supply tubes and liquid supply tubes may be formed so as to allow the directional flow of air and/or liquid. For example the tubes may have their side walls perforated.

Preferably the outer elongated housing or tube is covered by a layer of permeable material which restricts the passage of liquid and air and therefore enhances the production of foam.

The mixing chamber alternatively may be defined by the annular space between the air supply tube and outer housing or chamber and the solution is supplied to the annular space.

In a further embodiment, the foam production unit may comprise a nozzle. The nozzle may comprise a housing to which liquid and air may be supplied, the housing having an outlet which is restricted by a solid permeable material, typically in the form of a layer of such material. Alternatively the permeable material may comprise a perforated member.

The present invention in a further preferred aspect provides a method of growing plants using a growing medium which comprises a liquid foam. Preferably the liquid foam is formed by one or more of the above described methods and apparatus. Preferably, the foam comprises a foam which contains a plant nutrient or nutrients to promote the growth of plants.

The present invention in a further preferred aspect provides an apparatus for growing plants, said apparatus comprising a root chamber or compartment for containing the roots of said plants and means for supplying a liquid foam to said root chamber. The liquid foam as referred to above suitably contains a plant nutrient or nutrients.

Preferably the liquid foam is formed in a foam production unit as referred to above from a solution of nutrients and a foaming agent. The foaming agent may comprise a soluble organic emulsifying concentrate.

Apparatus in accordance with the invention for growing plants may be in a number of different configurations.

In one aspect, the apparatus may comprise an elongated chamber typically in the form of a pipe or tube through which a foam production unit may extend or which alternatively may be supplied with liquid foam. The elongated chamber may be provided with a plurality of spaced openings in which plants to be grown may be located.

The elongated, chamber may be oriented substantially horizontally or oriented substantially vertically. When in a vertical orientation, the elongated chamber may be defined by a plurality of separate compartments. The foam production unit may extend through and be located within the chamber or compartments. Alternatively, the foam production unit may be arranged externally with foam from the unit supplied to the respective compartments.

Elongated chambers of the above type may be mounted on a rotatable carousel to be rotatable about a vertical axis. Elongated chambers alternatively may be mounted on a frame for rotation about a horizontal axis.

In a further embodiment, the apparatus may comprise an open topped tray or compartment. A foam production unit may extend through the tray for supply of foam thereto. Alternatively the foam production unit may be provided in the base of the tray or compartment. Trays of the above type may be mounted on a rotatable frame for movement about a horizontal axis. Means such as pivot means may be provided to support the trays to maintain the trays in a substantially horizontal orientation when rotated.

According to a further aspect, the present invention provides an apparatus for growing plants, the apparatus comprising: an elongated chamber in the form of a pipe or tube; a foam production unit extending inside the elongated chamber; a plurality of spaced openings in the elongated chamber in which plants to be grown are located; and wherein the foam production unit provides a liquid foam from a solution of nutrients and a foaming agent, wherein the liquid foam containing the nutrients is supplied to the plants to promote the growth of the plants.

The foam production unit may be located externally of the elongated chamber and the liquid foam may be fed inside the chamber by a feed tube extending inside the elongated chamber. The elongated chamber may be oriented substantially horizontally or oriented substantially vertically. When oriented substantially vertically, the elongated chamber may be defined by a plurality of separate compartments, and the foam production unit extends through and be located within the chamber or compartments. The foam production unit may be arranged externally with foam from the unit supplied to the respective compartments.

Preferably the elongated chambers may be mounted on a rotatable carousel to be rotatable about a vertical axis. The elongated chambers may be mounted on a frame for rotation about a horizontal axis.

According to a further aspect, the present invention provides an apparatus for growing plants according to any of the features of the above foam production unit wherein the elongated chamber may be formed in any shape which allows the growth of plants.

According to a still further aspect, the present invention provides an apparatus for growing plants comprising: an open topped tray or compartment; a foam production unit extending through the tray for supply of foam thereto for promoting the growth of plants.

Preferably, the trays may be mounted on a rotatable frame for movement about a horizontal axis, wherein a pivot means may be provided to support the trays to maintain the trays in a substantially horizontal orientation when rotated. The foam production unit may be provided in the base of the tray or compartment.

According to a further aspect, the present invention provides an apparatus for growing plants comprising: a foam producing unit having an axis, a peripheral wall extending about said axis and having axially spaced apart opposite ends, and end walls closing said peripheral wall at said opposite ends, said peripheral wall and said end walls providing said foam producing unit with an interior for receiving an oxygenated air and liquid; a plurality of shaped projections extending outwardly from the peripheral wall of the foam production unit; a root chamber comprising a top wall, a bottom wall and side walls enclosing the root chamber and spaced apart end walls, at least one end wall having a complimentary shaped projection to receive the shaped projection extending from the peripheral wall of the foam production unit; said top wall having an opening for receiving a plant; and a means for controlling the flow of said oxygenated air and liquid through or from said foam producing unit and into said root chamber to thereby create a liquid foam which contains a plant nutrient or nutrients to promote the growth of plants.

Preferably, the peripheral wall of said foam producing unit may be formed In the shape of a polygon or the peripheral wall of said foam producing unit may be formed in the shape of a cylinder.

Preferably, the shaped projections extending from the peripheral wall may be either in the shape of a polygon or a cylinder.

Preferably, the foam production unit may further comprise projections extending outwardly from said end walls to receive said oxygenated gas and liquid. Said projections may be used to mount said apparatus for growing plants in a vertical arrangement. Said projections may be mounted into a carousel for rotating the growing apparatus.

Preferably, the apparatus for growing plants may further comprise at least one reflector mounted to an edge of side of said growing apparatus to reflect light to promote the growth of the plants.

Preferably, the apparatus for growing plants may further comprise at least one light source to promote the growth of plants.

The foam production method and apparatus described above may also be used for producing foam for fire suppression applications or any other applications where liquid foam is required. The liquid for forming the foam may include or comprise a fire suppressant liquid.

### BRIEF DESCRIPTION OF THE DRAWINGS

Reference will now be made to the accompanying drawings which illustrate preferred embodiments of the invention. The following embodiments are described in relation to the production of foam for growing of plants and a method and apparatus of growing plants in a liquid foam. It will be appreciated however that the described and illustrated foam production methods and apparatus may be used in any other application where liquid foam is required and thus the following description is not to be considered as limiting on the application of the invention or parts thereof. In the drawings:

FIG. 1 illustrates in schematic sectional view, a foam production unit according to a first embodiment of the present invention;

FIGS. 2 and 3 are schematic sectional views of alternative barn production units of the type illustrated in FIG. 1;

FIG. 4 illustrates in schematic sectional view of a portion of a foam production unit according to a further embodiment of the invention;

FIG. 5 is a schematic sectional view of a portion of a further foam production unit according to yet a further embodiment of the invention;

FIG. 6 illustrate in schematic sectional view a foam production unit according to a further embodiment of the invention;

FIGS. 7 and 8 illustrate in schematic sectional view, further foam production units of the type illustrated in FIG. 6;

FIG. 9 illustrates schematically a further foam production unit according to another embodiment of the invention;

FIG. 10 illustrates schematically a first embodiment of a growing unit according to the invention;

FIG. 11 illustrates a further embodiment of a growing unit;

FIGS. 12 and 13 are plan and isometric views of a growing tray according to another embodiment of the invention;

FIG. 14 illustrates a series of trays supported on a rotatable support structure;

FIG. 15 illustrates a further array of growing units;

FIGS. 16 and 17 illustrate a further growing unit in two different attitudes;

FIG. 18 is a sectional view of an upright growing unit;

FIG. 19 illustrates an alternative growing cell for use in the unit of FIG. 18;

FIG. 20 illustrates a further upright growing unit having an alternative arrangement for supply of liquid foam;

FIG. 21 illustrates a rotary carousel supporting a set of upright growing units;

FIG. 22 illustrates a further carousel for supporting an array of growing units;

FIG. 23 illustrates a further growing unit according to another embodiment of the invention;

FIG. 24 illustrates an access opening for the unit of FIG. 23;

FIG. 25 illustrates a series of joined growing units of the type illustrated in FIG. 23;

FIGS. 26 to 28 illustrate a further growing unit according to another embodiment of the invention;

FIG. 29 illustrates a further growing unit according to another embodiment of the invention;

FIG. 30 illustrates a pattern view of a flat piece of material for forming the three dimensional shape of FIG. 29;

FIG. 31 is a sectional view taken along arrows A-A of FIG. 29;

FIG. 32 illustrates a further growing unit according to another embodiment of the invention;

FIG. 33 illustrates a pattern view of a flat piece of material for forming the three dimensional shape of FIG. 32;

FIG. 34 illustrates a pattern view of a further growing unit according to another embodiment of the invention;

FIG. 35 illustrates three dimensional shape formed from FIG. 34;

FIG. 36 is a sectional view taken along arrows A-A of FIG. 35;

FIG. 37 illustrates a further growing unit according to another embodiment of the invention;

FIG. 38 illustrates a pattern view of a flat piece of material for forming the three dimensional shape of FIG. 37;

FIG. 39 is a sectional view taken along arrows A-A of FIG. 37;

FIG. 40 illustrates a further growing unit according to another embodiment of the invention;

FIG. 41 illustrates a pattern view of a flat piece of material for forming the three dimensional shape of FIG. 40;

FIG. 42 is a sectional view taken along arrows A-A of FIG. 40;

FIG. 43 illustrates a further growing unit according to another embodiment of the invention;

FIG. 44 illustrates multiple growing units of FIG. 43 supported on a rotatable support structure;

FIG. 45 illustrates the growing unit of FIG. 43 in an open position;

FIG. 46 illustrates a further growing unit according to another embodiment of the invention;

FIG. 47 illustrates yet a further growing unit according to another embodiment of the invention;

FIG. 48 illustrates yet a further growing unit according to another embodiment of the invention;

FIG. 49 shows a top view of a growing unit according to another embodiment of the invention;

FIG. 50 illustrates a pattern view of a flat piece of material for forming the three dimensional shape of FIG. 49;

FIG. 51 shows a top view of a growing unit according to another embodiment of the invention;

FIG. 52 illustrates a pattern view of a flat piece of material for forming the three dimensional shape of FIG. 51;

FIGS. 53 to 61 illustrate small type foam production units according to further embodiments of the invention;

FIGS. 62 to 64 illustrate longitudinal type foam production units according to further embodiments of the invention;

FIG. 65 illustrates an end cap for use on the longitudinal type foam production units of FIGS. 62 to 64; and

FIGS. 66 to 68 illustrate filter units used In the foam production units according to further embodiments of the invention.

### DESCRIPTION F THE PREFERRED EMBODIMENT

Referring to the drawings and firstly to FIG. 1, there is illustrated a foam production unit 1 for the production of a liquid foam, typically for use in growing plants, the unit 1 comprising a coaxial pipe or tube assembly 2 comprising an elongated air supply pipe or tube 3 which is perforated along its length, an outer pipe or tube 4 which is coaxially arranged with the air supply pipe 3, the outer pipe 4 also being perforated along its length or which is otherwise liquid permeable. The annular chamber 5 between the inner and outer pipes 3 and 4 define a mixing chamber in which air from the pipe 3 is mixed with a liquid supplied to the annular chamber 5. Surrounding the outer pipe 4 is an air pervious layer 6 which typically comprises a flexible open cell plastics foam or any other air pervious material. The foam or other material may be wrapped spirally around the outer pipe 4. Alternatively, the foam or other material may be formed into a self-supporting sleeve which may be located around the outer pipe 4 or comprise the outer pipe 4.

The inner and outer pipes 3 and 4 are joined at each end to respective supply manifolds 7 each having an inlet 8 for air communicating with the inner pipe 12 and an inlet 9 for liquid which communicates with the annular chamber 5 between the inner and outer pipes 3 and 4.

For producing a foam for growing of plants, a solution of water containing nutrients and a foaming agent, for example a soluble organic emulsifying concentrate is supplied to the Inlet 9 for flow into the annular chamber 5. The solution may be electromagnetically charged and enriched by minerals which is then mixed in a mixing tank with nutrients, emulsifying agent and other additives before supply to the inlet 9. The air inlet 8 is connected to a supply of oxygenated air which enters the air supply pipe 3 and into the annular chamber 5 and is mixed with the solution in the chamber 5. The outer air pervious layer 6 restricts the passage of the mixed solution and air from the chamber 5 to create a backpressure and therefore enhance the mixing of air and solution in the chamber and the creation of liquid foam. The liquid foam thus created exits the unit 1 through the layer 6 with the exiting foam comprising bubbles of oxygen or air trapped in membranes of water, minerals and nutrients.

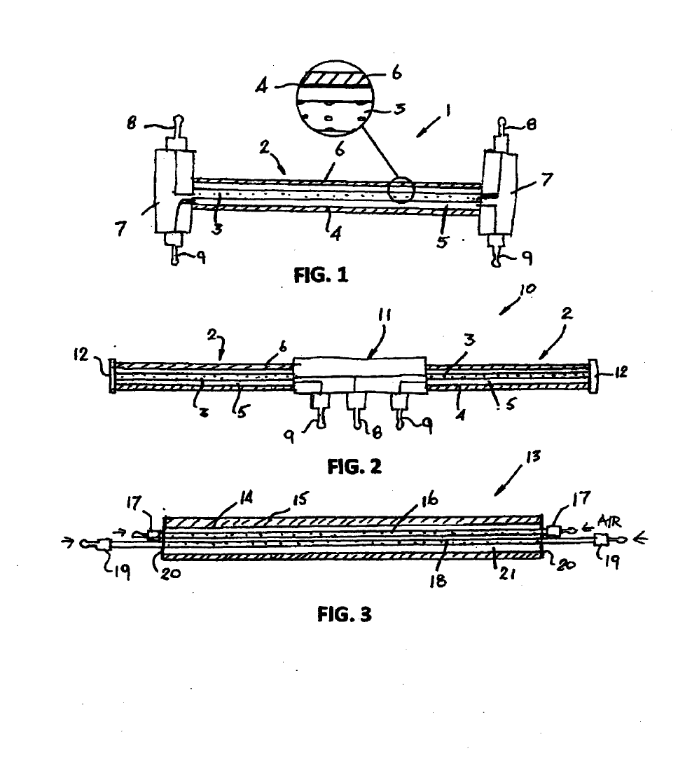

The embodiment of foam production unit 10 of FIG. 2 is similar to that of FIG. 1 and accordingly like components have been given like numerals. In this case however only a single central manifold 11 is provided and a pair of coaxial pipe assemblies 2 each comprising an inner air pipe 3 and outer solution pipe 4 connected to opposite ends of the manifold 11 with the outer free ends of the pipe assemblies 2 being closed at 12. The manifold 11 in this case includes a single air inlet 8 communicating with both pipes 3 and a pair of liquid inlets 9 communicating with the respective annular chambers 5 of the respective pipe assemblies 2.

The embodiment of foam production unit 13 of FIG. 3 includes an outer perforated or liquid permeable tube 14 surrounded by the air permeable layer 15. Extending longitudinally of and within the tube 14 are a first air pipe 16 having inlets 17 at one or both ends and a second liquid pipe 18 having inlets 19 at one or both ends. Opposite ends of the tube 14 are dosed at 20 whilst the pipes 16 and 18 pass through the ends 20 and are sealed thereto so that the interior 21 of the tube 14 is substantially sealed.

Both of the embodiments of FIGS. 2 and 3 function in the manner described with reference to FIG. 1 with air and liquid supplied to the units 10 and 13 mixing and exiting through the permeable layers 6 and 15 as a liquid foam along the length of the layers 6 and 15.

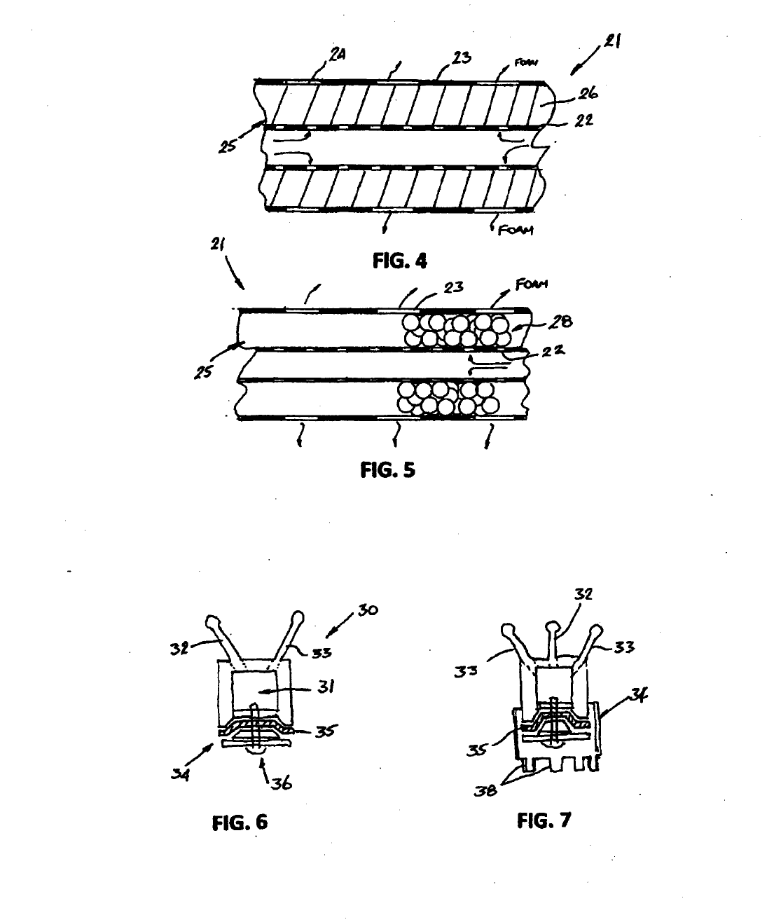

Referring now to FIG. 4, there is illustrated part of a coaxial pipe or tube assembly 21 of a further foam production unit comprising an inner perforated pipe 22 and an outer pipe 23 which is perforated or slotted as at 24. Located in the annular space 25 between the pipes 22 and 23 is a permeable material 26 for example a flexible open cell plastics foam or any other air pervious material as referred to above. Air and liquid introduced into the inner pipe 22 passes outwardly through the perforations or openings 27 in the inner tube 22 and through the permeable material 26 which creates a back pressure in the tube 22. The pressured air and liquid are forced through the material 26 causing aeration of the liquid and creation of foam which exits through the slots or openings 24.

The embodiment of FIG. 5 is similar to FIG. 4 comprising a similar pipe or tube assembly 21 however in this embodiment, the annular space 25 is provided with a plurality of discrete members in this case spheres 28. The spheres 28 create a non-direct path between the inner pipe apertures 22 and outer pipe slots or apertures 24 thereby also creating a back pressure and also causing mixing of air and liquid in the space 25 and creation of foam which again will exit through the slots 24.

Referring now to FIG. 6, there is illustrated a nozzle 30 for creating the above foam which uses the same principles as the units of FIGS. 1 to 5. The nozzle 30 Includes a mixing chamber 31 (equivalent to the chamber 14 of FIG. 1) having an inlet 32 for the liquid solution and an inlet 33 for air. The outlet 34 from the chamber 31 is closed by an air permeable layer 35. As with the embodiments of FIGS. 1 to 3, air and liquid/nutrient solution supplied through the inlets 32 and 33 are mixed in the chamber 31 and created liquid foam is forced through the foam layer 35. The layer 35 may be compressed by screw clamp 36 to vary the permeability of the layer 35.

In the embodiment of nozzle of FIG. 7 which is similar to that of FIG. 6, an outlet manifold 37 surrounds the outlet 34, the manifold 34 having a series of outlets 38 for supply of the liquid foam. The nozzle of FIG. 5 has a single solution inlet 32 and a pair of air inlets 33.

In the embodiment of foam production unit 40 of FIG. 8, a double ended nozzle 41 is provided, the nozzle 41 having a mixing chamber 42 split into two chamber parts 43, each having an outlet 44 including respective air permeable layers 45 with the respective chamber parts 43 supplied with solution by a common inlet 46 and respective air inlets 47. Elongated outlet manifolds 48 are supplied with foam from the chamber outlets 44 with each manifold 48 being provided with spaced foam outlets 49 for supplying foam to different locations.

The foam production unit 50 of FIG. 9 is of a substantially flat or planar configuration and includes a hollow base member 51 which defines a chamber 52 through which a plurality of air pipes 53 and liquid pipes 54 pass, each pipe 53 and 54 being perforated or liquid permeable such that air and liquid can mix in the chamber 52. The top of the chamber is closed by a permeable layer 55 such as a solid foam as above. A top perforated plate 56 is located above the layer 55 and may compress the layer 55 to vary the permeability thereof.

As with the previous embodiments, air and solution supplied by the pipes 53 and 54 mixes in the chamber 52 to create a liquid foam which is forced out through the permeable layer 55 and perforated plate 56.

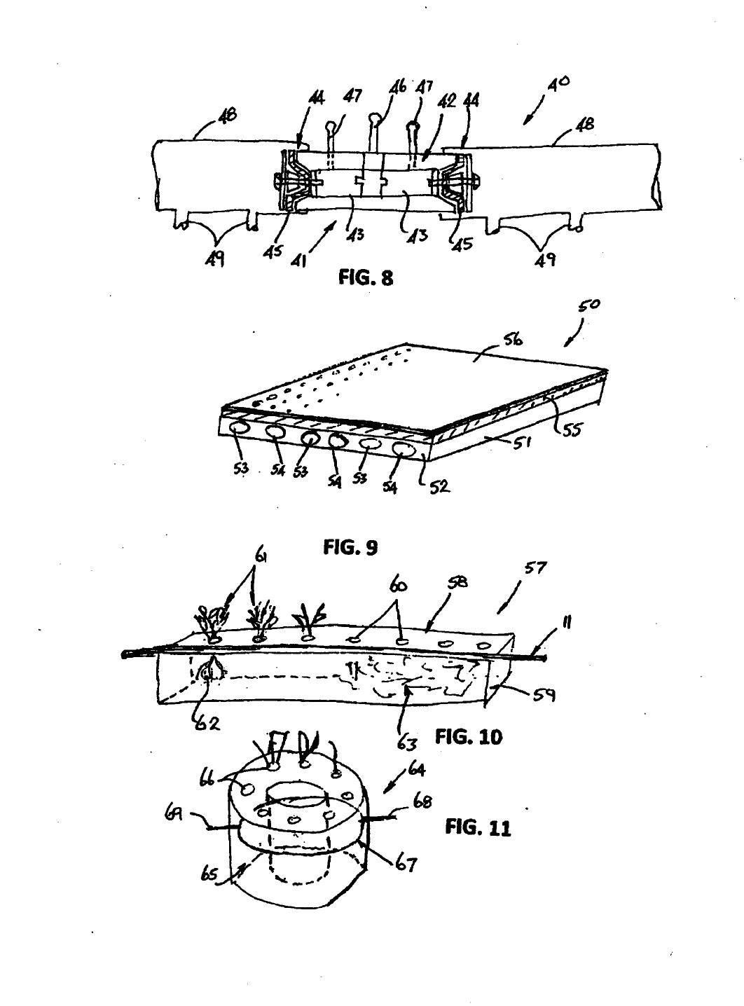

The foam production units or nozzles as described above may be used in many different configurations for the supply of nutrients for growing of plants. FIG. 10 illustrates a first plant growing unit 57 comprising an elongated housing 58 defining a hollow chamber 59. A plurality of openings 60 are provided on the upper side of the housing 58 into which plants 61 to be grown may be inserted such that the roots 62 thereof are located within the chamber 59. Extending within and longitudinally of the chamber 59 is a coaxial pipe or tube assembly 11 of a foam production unit 10 as described above in reference to FIGS. 1 to 5. Operation of the foam production unit 10 will result in the production of liquid foam 63 which is forced out of the tube assembly 11 into the chamber 59 to substantially fill the chamber 59. The plant roots 55 are thus directly located within and exposed to the nutrient foam 63. As the roots are directly exposed to the foam 63, absorption of nutrients in the foam is substantially increased resulting in efficient growing. In addition, any treatment additives or nutrient additives may be introduced via the tube assembly 11 using the same system. A further advantage is that water use is substantially reduced. The foam will remain in the chamber 59 for a substantial period of time however the chamber 59 may be recharged with foam by operation of the foam production unit 10 as and when required.

Whilst the chamber 59 of FIG. 10 is shown to be of a rectangular or square cross section, the chamber 59 may be defined by a pipe of circular cross section. Further whilst the housing 58 is shown in a horizontal attitude, a similar housing 58 may be oriented in a vertical attitude as described further below.

In the embodiment of FIG. 11, the housing 64 is of a circular configuration and defines an annular chamber 65 with a series of openings 66 provided in spaced apart circumferential locations in a top wall of the housing 64. The coaxial pipe assembly 67 of the foam production unit in this case is in a circular configuration to supply foam to the annular chamber 65. A series of housings 64 may be connected together with the foam supplying pipe assemblies 67 being connected through joined inlets 68 and outlets 69.

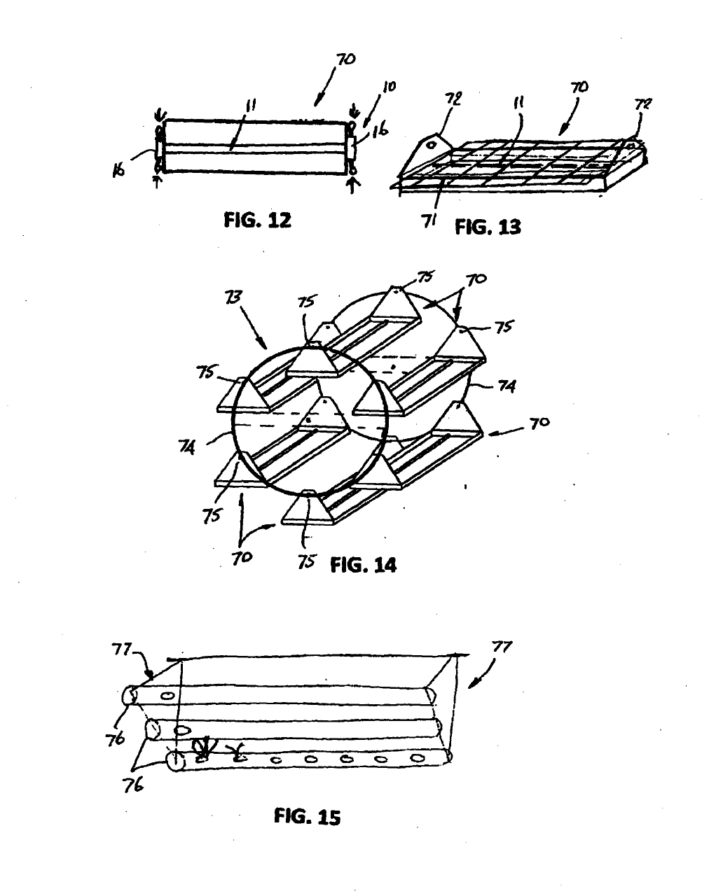

FIGS. 12 and 13 illustrate a further embodiment of growing apparatus in the form of a tray 70, the tray 70 being of a substantially rectangular configuration and of shallow depth and a foam production unit 10 of the type disclosed in FIG. 1 is mounted to the tray 70 such that the tube assembly 11 extends longitudinally and centrally of the tray 70. A plant holding mesh 72 may be located over the top of the tray 70 to support plants for growing in the tray 70. The trays 70 may be supported in a fixed position on the ground. The trays alternatively may be provided with upstanding ends 72 for pivotally mounting the trays 72 in a horizontal attitude.

A rotatable frame assembly 73 shown in FIG. 14 comprising a pair of end circular or annular members 74 which are mounted for rotation about a horizontal axis can support a plurality of trays 70 which are pivotally mounted by the ends 72 at 75 to the receptive end members 73 and at different circumferential locations. The frame assembly 73 permits a series of trays 70 to be supported for growing plants in a limited space whilst the position of each tray 70 can be moved by rotation of the end members 74 whist the pivotal mounting of the trays 70 ensures that they will maintain a substantially horizontal attitude in all positions. Common manifolds may be supported on the end members 74 for supply of air and solution to the respective units 10 on the trays 70.

As an alternative to the trays 70, a series of elongated tubular bodies 76 may be supported alongside each other in a parallel relationship with each body 70 being similar in configuration to the bodies 57 of FIG. 10. As shown in FIG. 15 spaced triangular frames 77 may support the bodies 76 in this relationship with the frames 77 being capable of being supported on the rotatable frame assembly 73 between the end members 74 in place of the trays 70.

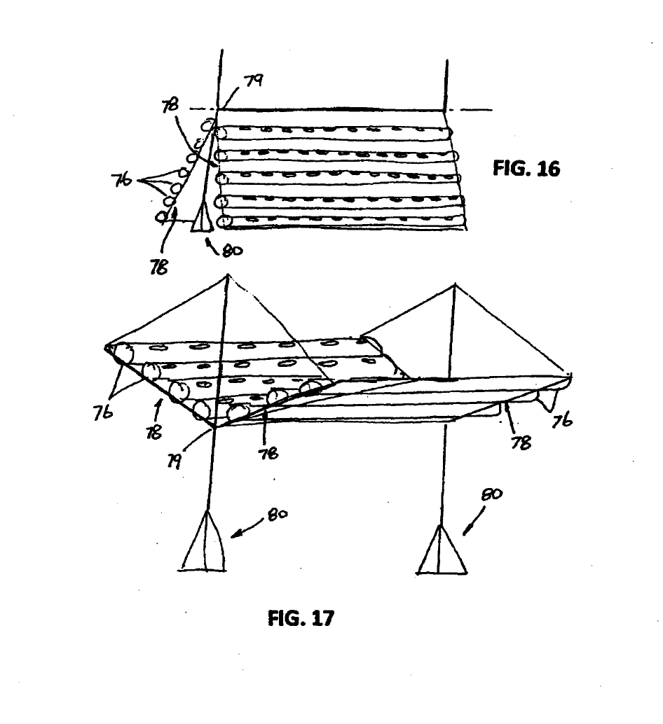

In an alternative arrangement, the elongated bodies 76 may be mounted in two rows one above the other as shown in FIG. 16 on respective frames 78 pivotally interconnected at 79 and supported on end stands 80. The frames 78 may be moved between the position illustrated in FIG. 16 where the frames 78 are angled acutely relative to each other to the position of FIG. 17 where the frames 78 may be moved to a position in which they are arranged at an acute angle relative to each other such that the bodies 76 are all exposed directly to the sun.

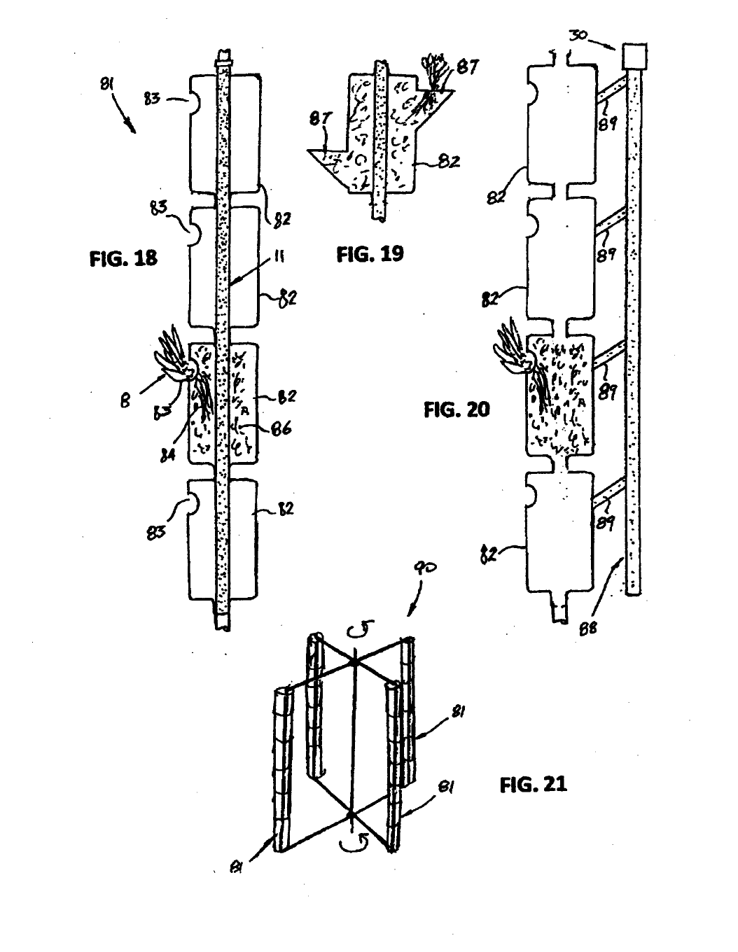

As referred to above, plants also may be grown in an upright attitude using an elongated housing 58 of the type shown in FIG. 10 in an upright attitude. The upright housing 81 in the embodiment of FIG. 18 may be defined by a series of separate compartments 82 with a coaxial tube assembly 11 for supplying foam extending through each compartment 82. Each compartment 82 also has at least one opening 83 in a side wall into which the roots 84 of plants 85 to be grown may be inserted. Foam 86 supplied by the tube assembly 11 will fill each compartment 82 to surround the roots 84. In the embodiment of FIG. 19, the compartments 82 are of cylindrical configuration and may be defined by hollow plastic bottles. The compartments 82 however may be of other configurations. For example in the embodiment of FIG. 19, the compartments 82 may be extended on opposite sides to define horizontally oriented chambers 87 into which the plants to be grown may be inserted.

In the embodiment of FIG. 20, a supply tube 88 is arranged externally of the housing 81 and extends parallel thereto. A nozzle 30 is provided to supply foam to the tube 88 with feed tubes 89 extending between the supply tube 88 and compartments 82 for supplying foam created by the nozzle 30 to the compartments 82. The foam supply arrangement is similar to the embodiment of foam production units of FIGS. 1 to 5. The foam supply arrangement however may be similar to the unit 40 of FIG. 8.

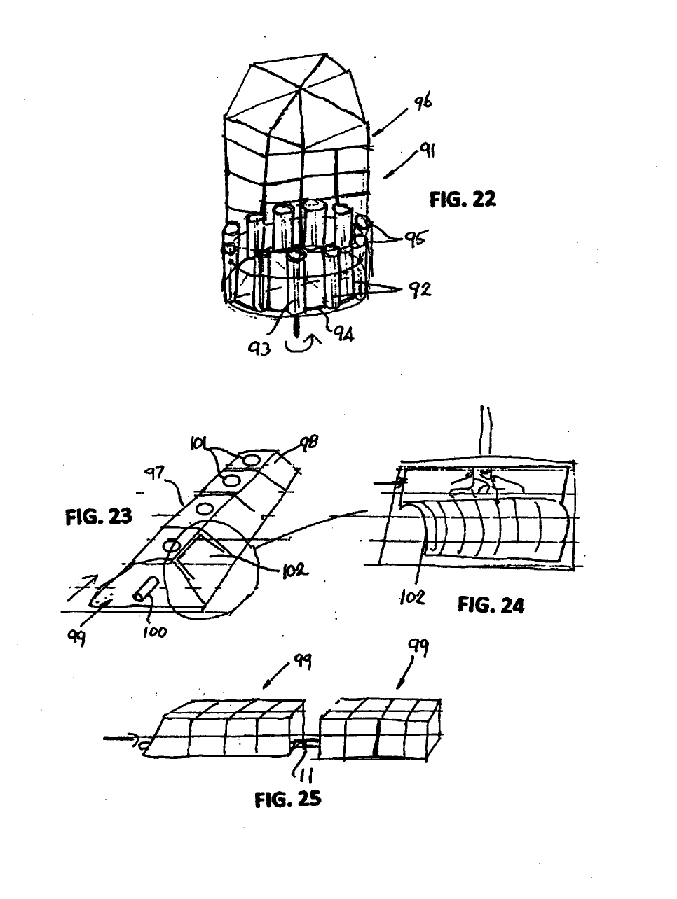

A series of units 81 may be supported on a rotatable carousel 90 as shown in FIG. 21 which may be rotated about a vertical axis to position the respective housings 81 in turn in position for maximum growth for example by exposure to the elements.

In the embodiment of FIG. 22, a further carousel 91 is provided in which a series of upright tubes or housing 92 are arranged in a circumferential spacing with each tube or housing 92 having an upright foam supply tube 93, the respective supply tubes 93 being supplied with air and solution by a circular manifold 94. The upper ends 95 of the housings 92 are open so that plants can be inserted therein. A supporting frame or grid 96 is mounted to the carousel above the housings 92 to support the plants as they grow.

In the embodiment of FIG. 23, a frame 97 of this embodiment of trapezoidal shape is covered with a plastics film 98 to define a root compartment 99 for foam with a foam supply tube 100 extending through the compartment 99. Spaced openings 101 are provided in the top wall of the compartment 99 to receive plants for growing the roots of which are exposed to foam within the compartment 99. Access to the interior of the compartment 99 may be provided by a flap 102 of the film 98 (see FIG. 24)

Certain sections of the compartment 99 may be covered with a film of transparent material to form a greenhouse-like arrangement suitable for propagation of seedlings, grass, bean sprouts or the like. Access provided by the flap 102 allows for harvesting of sprouts, seedlings etc when required.

A series of compartments 99 may be connected together as in FIG. 25 with foam supplied by a common tube assembly 11.

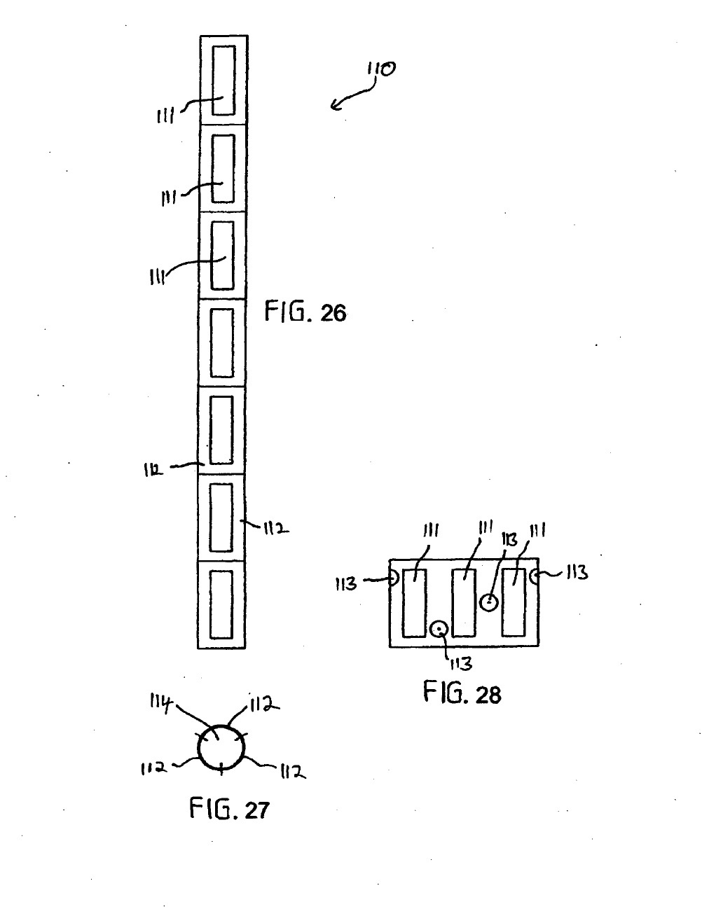

In the embodiment of FIGS. 26 to 28, a frame 110 of this embodiment of cylindrical shape and defines a root compartment 114 into which foam from a foam supply tube 113 extends through the compartment 114. Spaced openings 111 are provided in each side wall 112 of the compartment 114 to receive plants for growing the roots of which are exposed to foam within the compartment 114.

A series of compartments 114 may be connected together as in FIG. 26 with foam supplied by a common tube assembly 113.

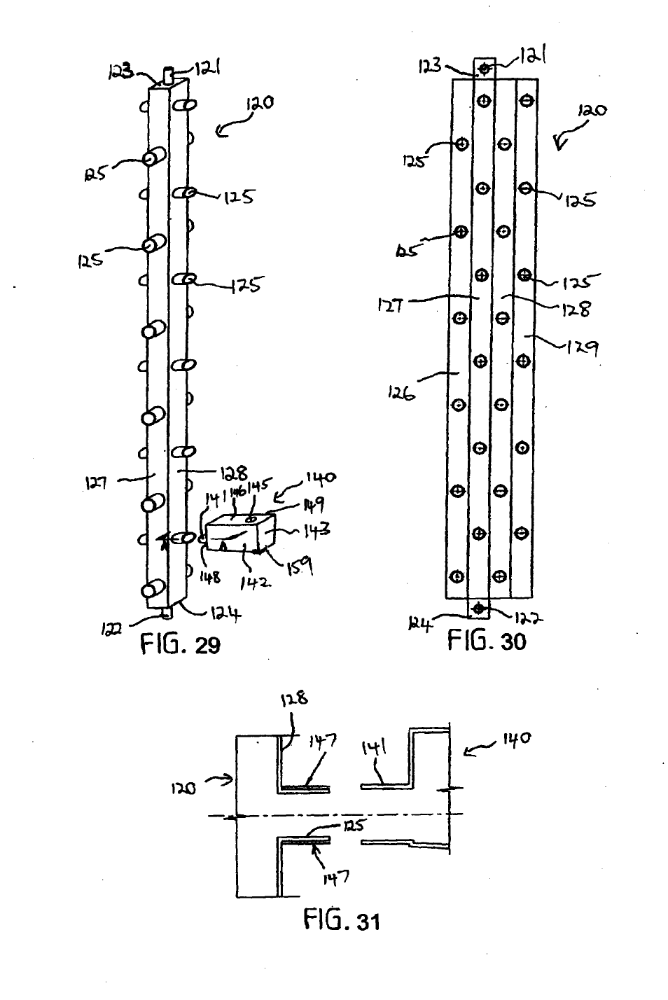

In the embodiment of FIGS. 29 to 31, the growing unit consists of two components a foam supply unit 120 and a root compartment 140. The foam supply unit 120 consists of a housing having four sides 126, 127, 128, 129 and spaced apart ends 123 and 124. The housing shown in FIG. 29 has a square cross-section with multiple feed tubes 125 spaced apart and extending outwardly from each of the four sides. Opposite housing sides 127 and 129 have sets of feed tubes 125 aligned along a common horizontal axis and extending outwardly from each side 127 and 129. Likewise sides 126 and 128 have sets of feed tubes 125 aligned along a common horizontal axis and extending outwardly from each side 126 and 128. Formed on either end 123, 124 and extending from the ends are supply tubes 121 and 122 for feeding air and a liquid to form the foam.

The supply tubes 121, 122 may also be used to mount the foam supply unit 120 in a vertical arrangement. Furthermore multiple foam supply units 120 may be mounted on a rotatable or stationary carousel (not shown) to form multiple upright foam supply units.

The root compartments 140 are attached to the feed tubes 125 via tube 141. The root compartment 140 is formed in a rectangular prism with sides 142, 146, 149, 159 and ends 143 and 148. The tube 141 extends outwardly from end 148 and when mounted to the foam supply unit 120 is sealed around the feed tube 125 by a rubber seal 147 as shown in FIG. 31. An opening 145 in the side 146 of the root compartment 140 is used to receive plants for growing. The roots of the plants are exposed to the foam within the root compartment 140.

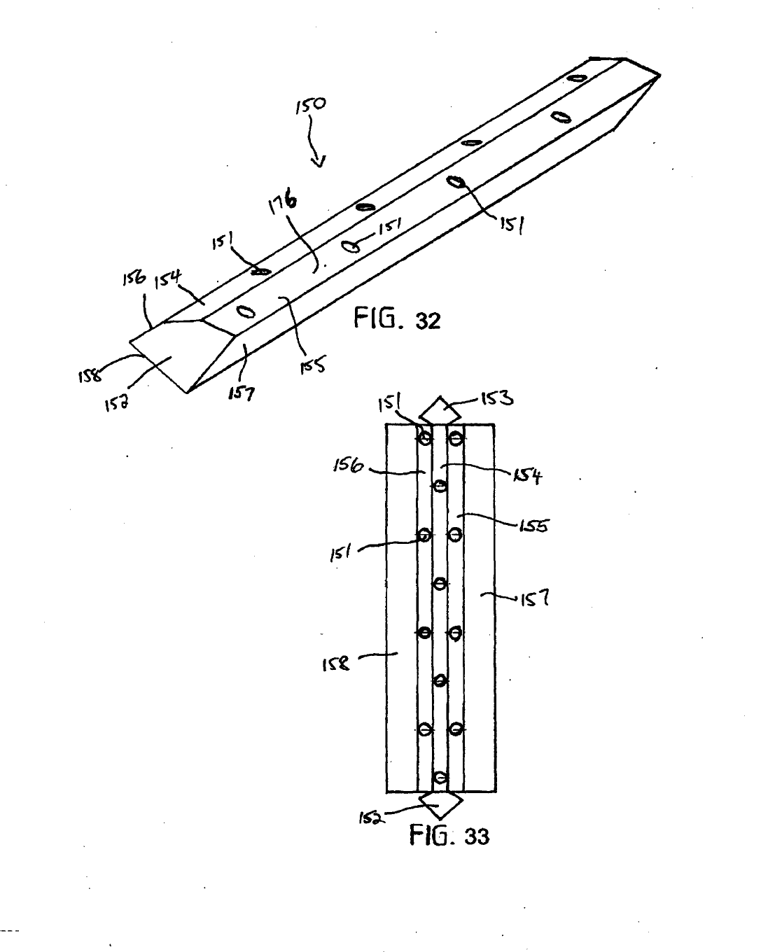

In the embodiment of FIGS. 32 and 33, the growing unit consists of a frame 150 of a pentagonal shape defining a root compartment 176 for foam with a foam supply tube (not shown) extending through the compartment 176. The frame 150 consists of sides 154, 155, 156, 157, 158 and spaced apart ends 152 and 153. Spaced openings 151 are provided in the top walls 154, 155, 156 of the compartment 176 to receive plants for growing the roots of which are exposed to foam within the compartment 176.

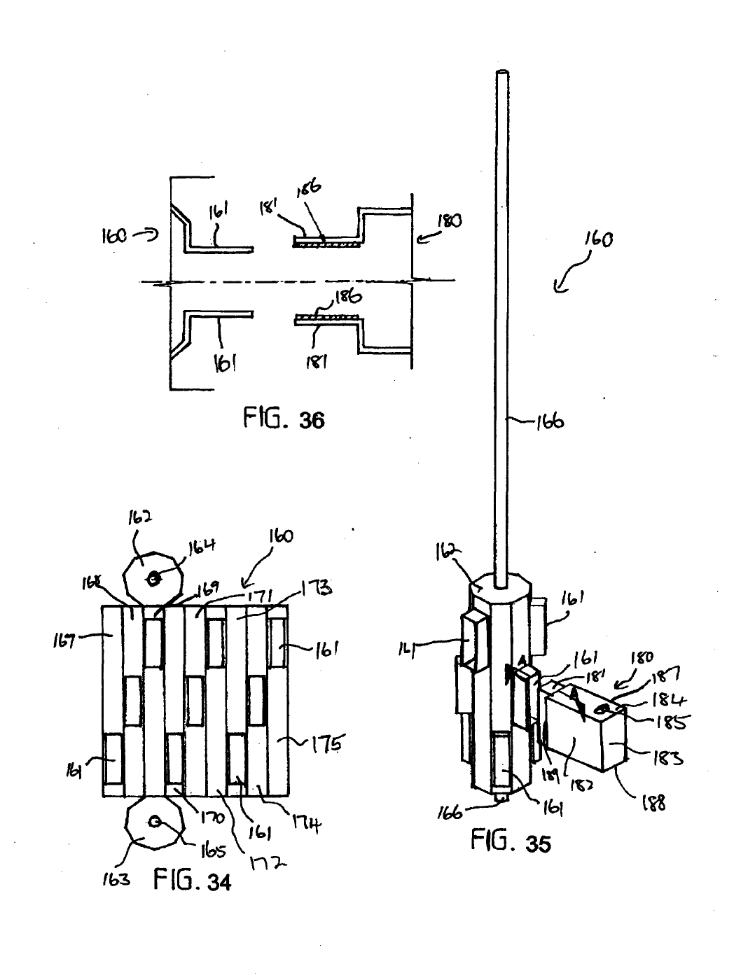

In the embodiment of FIGS. 34 to 36, the growing unit consists of two components a foam supply unit 160 and a root compartment 180. The foam supply unit 160 consists of a housing having nine sides 167 to 175 and spaced apart ends 162 and 163. The housing shown in FIG. 35 consists of nine equal sides forming a regular nonahedron with multiple feed tubes 161 spaced apart and extending outwardly from each of the nine sides. The multiple feed tubes 161 are rectangular in shape.

On either end 162, 163 of the foam supply unit 160 are openings 164, 165 for receiving a coaxial tube assembly 166 for feeding air and a liquid to form the foam. Foam supplied by the tube assembly 166 will fill each foam supply unit 160.

Multiple foam supply units 160 may be inserted onto the tube assembly 166 to form an upright growing unit. As referred to above, plants also may be grown in an upright attitude of the type shown in FIG. 35 in an upright attitude. Multiple foam supply units may be formed by a series of separate foam supply units 160 with a coaxial tube assembly 166 for supplying foam extending through each foam supply unit 160. Each foam supply unit 160 has multiple feed tubes 161 in the side walls. Foam supplied by the tube assembly 166 will fill each foam unit 160.

The root compartments 180 are attached to the feed tubes 161 via tube 181. The root compartment 180 is formed in a rectangular prism with sides 182, 184, 187, 188 and ends 183 and 189. The tube 161 extends outwardly from end 189 and when mounted to the foam supply unit 160 is sealed around the feed tube 161 by a rubber seal 186 as shown in FIG. 36. An opening 185 in the side 184 of the root compartment 180 is used to receive plants for growing. The roots of the plants are exposed to the foam within the root compartment 180.

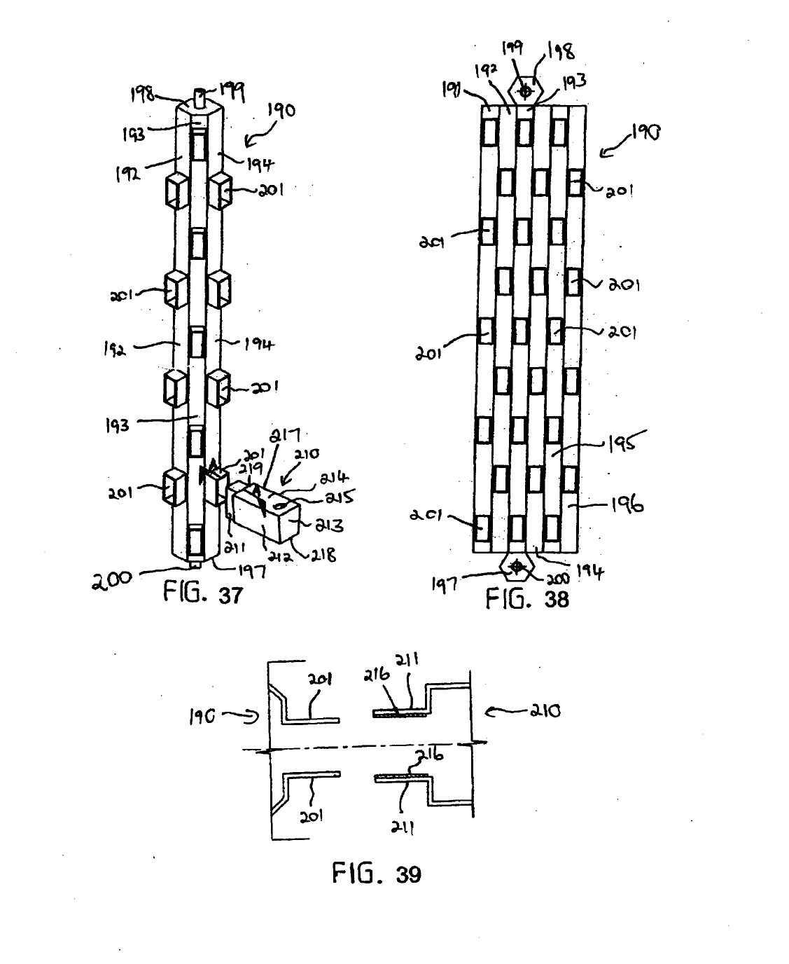

In the embodiment of FIGS. 37 to 39, the growing unit consists of two components a foam supply unit 190 and a root compartment 210. The foam supply unit 190 consists of a housing having six sides 191, 192, 193, 194, 195, 196 and spaced apart ends 197 and 199. The housing shown in FIG. 37 consists of six equal sides forming a regular hexagon with multiple feed tubes 201 spaced apart and extending outwardly from each of the six sides. The multiple feed tubes 201 are rectangular in shape.

Formed on either end 197, 198 and extending from the ends are supply tubes 199 and 200 for feeding air and a liquid to form the foam.

The supply tubes 199, 200 may also be used to mount the foam supply unit 190 in a vertical arrangement. Furthermore multiple foam supply units 190 may be mounted on a rotatable or stationary carousel (not shown) to form multiple upright foam supply units 190.

The root compartments 210 are attached to the feed tubes 201 via tube 211. The root compartment 210 is formed in a rectangular prism with sides 212, 214, 217, 218 and ends 213 and 219. The tube 211 extends outwardly from end 219 and when mounted to the foam supply unit 190 is sealed around the feed tube 201 by a rubber seal 216 as shown in FIG. 39. An opening 215 in the side 214 of the root compartment 210 is used to receive plants for growing. The roots of the plants are exposed to the foam within the root compartment 210.

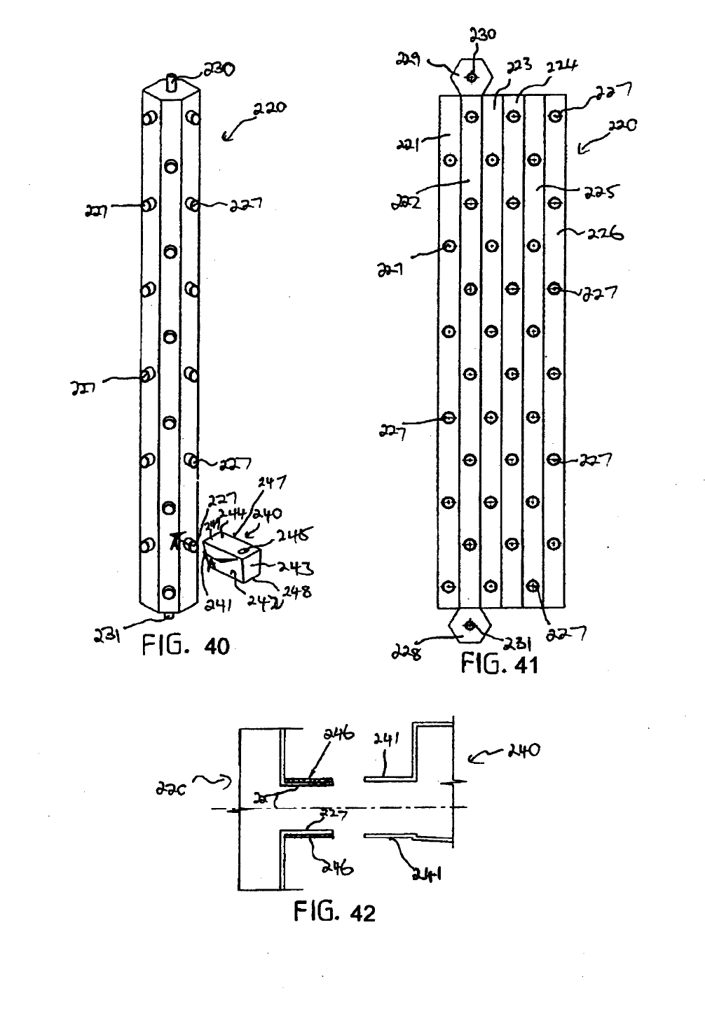

In the embodiment of FIGS. 40 to 42, the growing unit consists of two components a foam supply unit 220 and a root compartment 240. The foam supply unit 220 consists of a housing having six sides similar to that of FIGS. 37 to 39. The housing shown in FIG. 40 consists of six equal sides 221, 222, 223, 224, 225, 226 forming a regular hexagon with multiple feed tubes 227 spaced apart and extending outwardly from each of the six sides. The multiple feed tubes 227 differ from FIGS. 37 to 39 in that they are circular in shape.

Formed on either end 228, 229 and extending from the ends are supply tubes 230 and 231 for feeding air and a liquid to form the foam.

The supply tubes 230, 231 may also be used to mount the foam supply unit 220 in a vertical arrangement. Furthermore multiple foam supply units 220 may be mounted on a rotatable or stationary carousel (not shown) to form multiple upright foam supply units 220.

The root compartments 240 are attached to the feed tubes 227 via tube 241. The root compartment 240 is formed in a rectangular prism with sides 242, 244, 247, 248 and ends 243 and 249. The tube 241 extends outwardly from end 249 and when mounted to the foam supply unit 220 is sealed around the feed tube 227 by a rubber seal 246 as shown in FIG. 42. An opening 245 in the side 244 of the root compartment 240 is used to receive plants for growing. The roots of the plants are exposed to the foam within the root compartment 240.

In the embodiment of FIGS. 43 to 45, a frame 250 having an elliptical shape defines a root compartment 254 for foam with a foam supply tube 251 extending through the compartment 254. Spaced openings 253 are provided in the side walls of the compartment 254 to receive plants for growing the roots of which are exposed to foam within the compartment 254. Access to the interior of the compartment 254 is achieved by opening the frame 250 thereby separating the two halves of the elliptical shaped root compartment 254 when required and as shown in FIG. 45. The exterior profile of the frame 250 consists of raised sections 252 and lower sections 255 joined by an intermediate section 256.

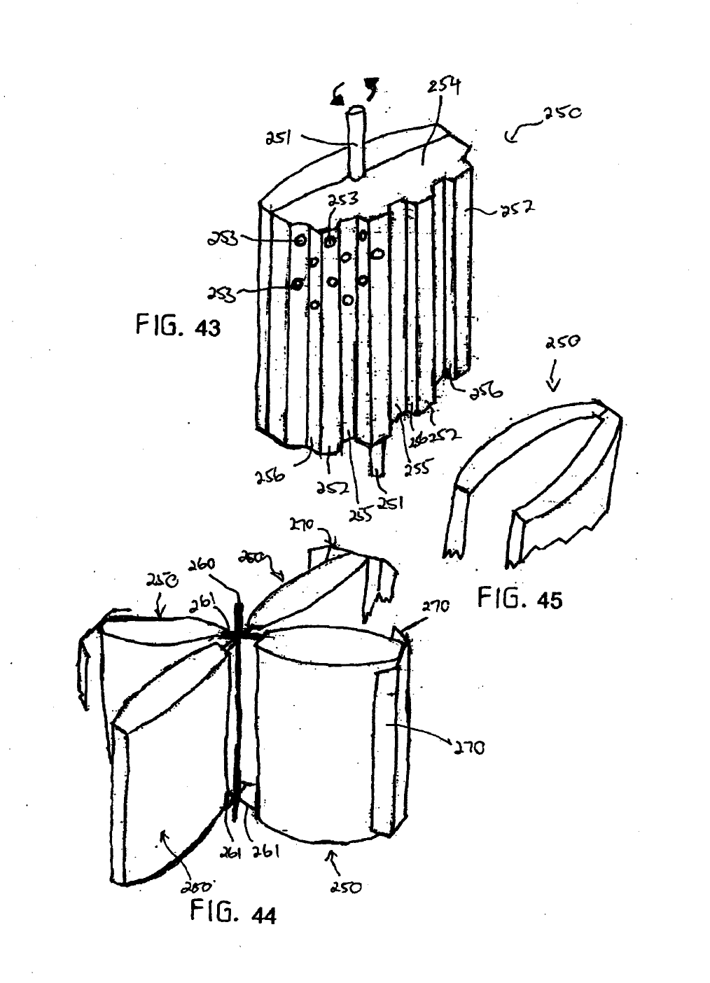

As shown in FIG. 44 a series of frames 250 may be connected together as in FIG. 44 with foam supplied by a common tube assembly 260. The series of frames 250 are mounted on a rotatable or stationary carousel to form a multiple upright series of frames 250. The series of frames 250 are connected to the tube assembly 260 by members 261 located at the top and bottom of each frame 250. The combined system of frames 250 also includes a reflector 270 used to reflect light to all sides of the frame 250.

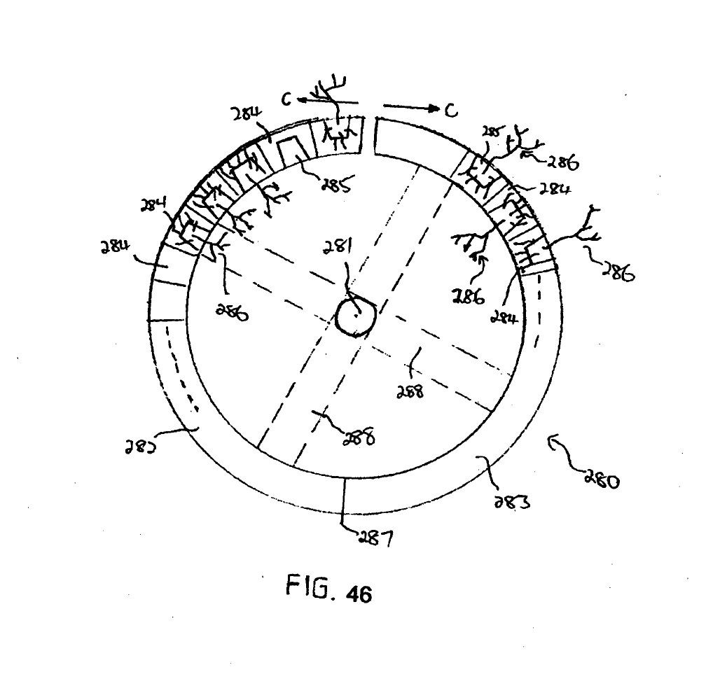

In the embodiment of FIG. 46, a cylindrical frame 280 similar to that of FIGS. 26 to 28 is utilised to grow plants 286. The circular frame 280 consists of two half shells 282 and 283 joined at one side 287 and able to be separated in the direction of arrows C on the opposite side. The two half shells 282, 283 are separated into compartments 284 in which growing containers 285 are inserted. The growing containers 285 may be containers for growing plants 286 or may form a recess for receiving further containers for growing plants 286. The compartments 284 are accessible from either side of the circular frame 280 thereby allowing plants 286 to be grown on either side of the two half shells 282, 283.

The cylindrical frame 280 is mounted on either a fixed or rotatable carousel which consists of a central tube 281 extending through the middle of the cylindrical frame 280. The central tube 281 may be used to supply the foam for growing the plants 286 as well as any power supply required for such items as lighting or for rotating the carousel. When used to supply the foam for growing the plants 286 cross members 288 are used to direct the foam to the two half shells 282, 283. The cross members 288 may also be used to support the frame 280 on the carousel.

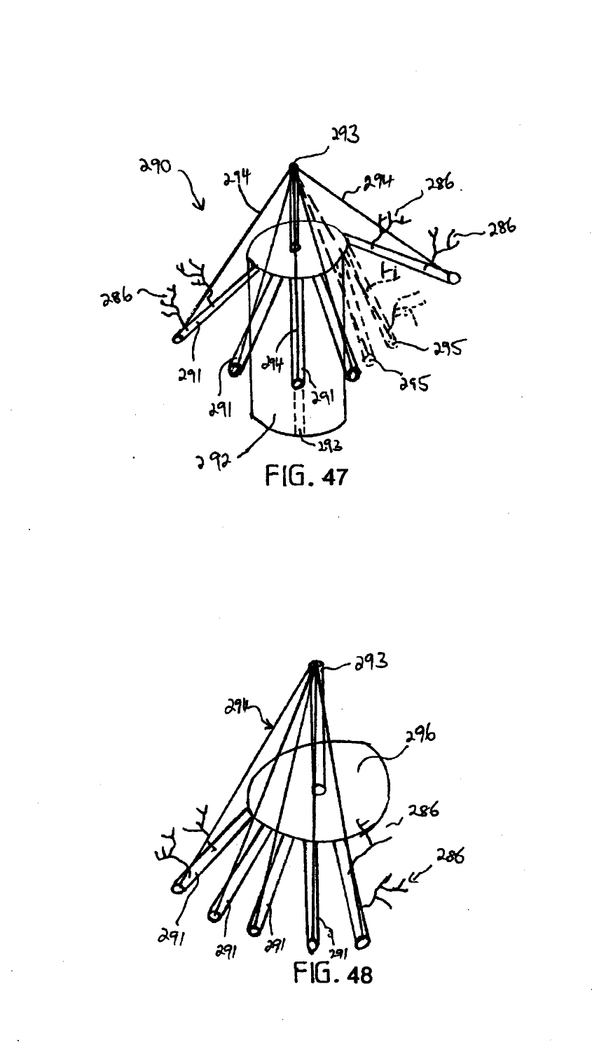

In the embodiment of FIGS. 47 and 48 systems in the shape similar to that of an umbrella are used to grow plants 286. In FIG. 47 a standing umbrella unit 290 is mounted upon a cylinder 292 with a feed tube 293 being located and extending through the cylinder 292. The feed tube 293 is used to supply the foam to the growing tubes 291 to feed the foam to the plants 286. The top section of the feed tube 293 is also used to attach the raising and lowering mechanism for the growing tubes 291. In this embodiment the raising and lowering mechanism is a rope and pulley system. However any other known means may be utilised to raise and lower the growing tubes 291. Also shown in this embodiment growing tubes 295 are shown lowered further down than the other growing tubes 291. This may occur when the weight of the plant increase due to growth.

In FIG. 48 a suspended or hanging umbrella system is used to grow plants 286. The feed tube 293 may be attached to a ceiling or suspended at some point from the ceiling. The growing tubes 291 are attached to a cylindrical member 296 at one end of the growing tube 291. At the other end of the growing tube 291 and as for the embodiment of FIG. 47 the raising and lowering mechanism is attached at this other end. The feed tube 293 is used to supply the foam to the growing tubes 291 to feed the foam to the plants 286

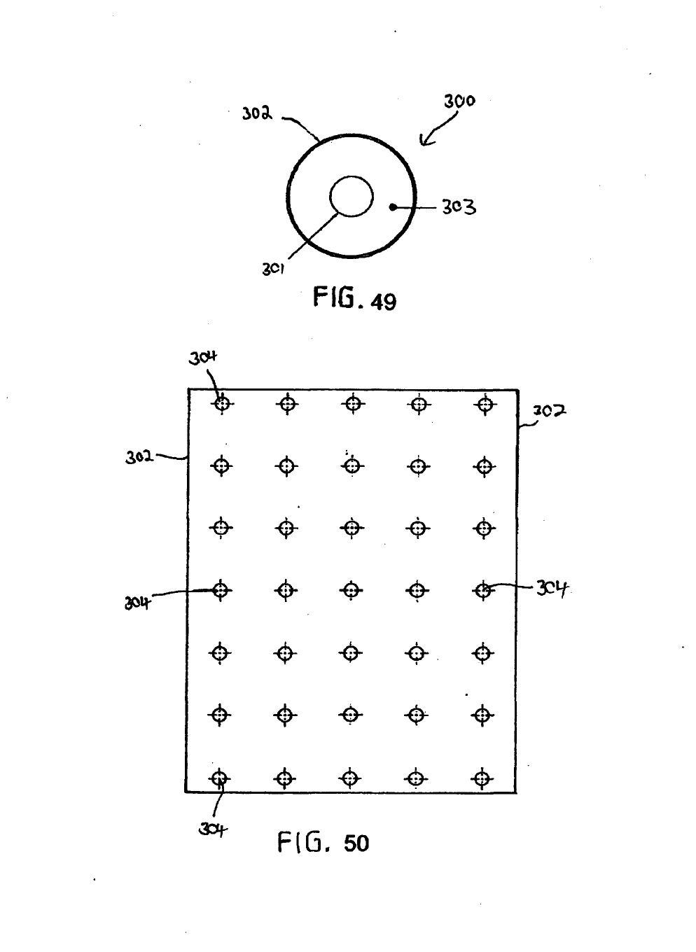

In the embodiment shown in FIGS. 49 and 50, a further cylindrical growing unit 300 is shown with the growing baskets or root compartments located on the outer surface 302. In this embodiment the space 303 between the inside wall 301 and outside wall 302 is used for growing baskets (not shown). The inside wall 301 can be used to supply the air and liquid for producing the foam for growing plants. It is also possible to use the inside wall to simply supply the air and have the liquid solution dispersed into the space 303 between the inside wall 301 and the outside wall 302. When the air is then introduced to the liquid solution the foam is produced to provide the nutrient foam. The openings 304 in the outside wall 302 are the access points for inserting the plants into the growing basket or area in between the inside wall 301 and the outside wall 302.

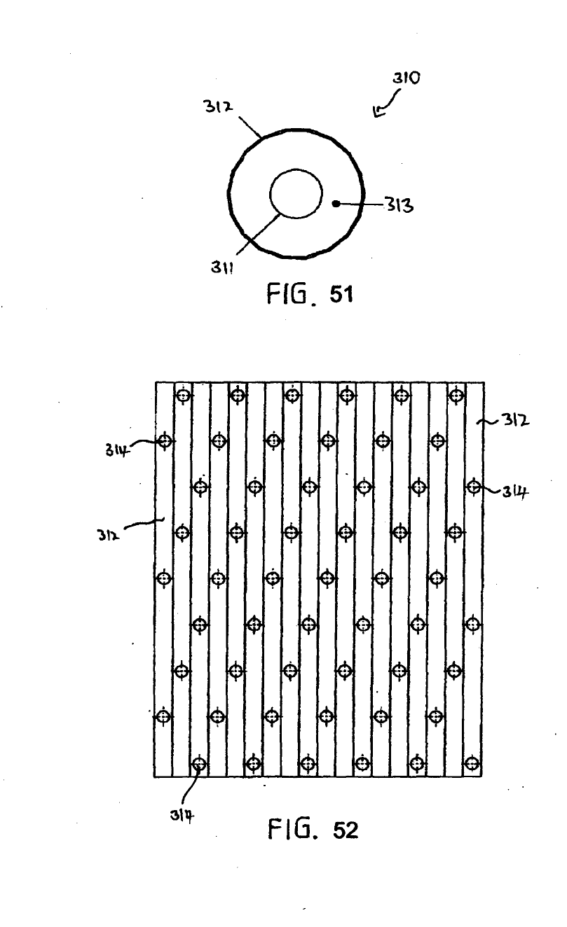

In the embodiment shown in FIGS. 51 and 52 the outside wall 312 in this case is in the shape of an 18 sided growing unit 310 with a cross sectional shape of a regular octadecogon. The growing unit 310 is shown with the growing baskets or root compartments located on the outer surface 312. In this embodiment the space 313 between the inside wall 311 and outside wall 312 is used for growing baskets (not shown). The inside wall 311 can be used to supply the air and liquid for producing the foam for growing plants. It is also possible to use the inside wall to simply supply the air and have the liquid solution dispersed into the space 313 between the inside wall 311 and the outside wall 312. When the air is then introduced to the liquid solution the foam is produced to provide the nutrient foam. The openings 314 in the outside wall 312 are the access points for inserting the plants into the growing basket or area in between the inside wall 311 and the outside wall 312.

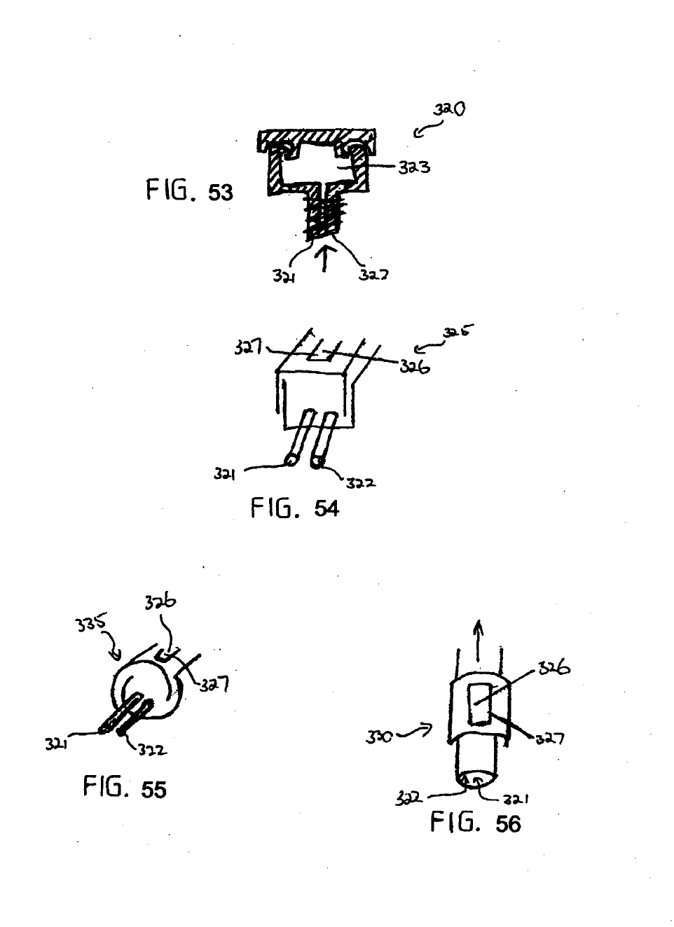

FIGS. 53 to 61 show different types of small nozzles 320, 325, 330, 335, 340, 345, 350, 355 and 360 which may be used in the foam production units to control the direction or characteristics of a fluid or gas flow as it exits or enters an enclosed chamber or pipe via an orifice. As shown in FIGS. 53 to 61 a nozzle is a pipe or tube of varying cross sectional area, and is used to direct or modify the flow of a fluid (liquid or gas). In use nozzles are used to control the rate of flow, speed, direction, mass, shape, and/or the pressure of the stream that emerges from the nozzle.

FIG. 53 shows a nozzle 320 which contains a layer of solid foam 323. The layer of solid foam 323 may be replaced by screen or any other hard penetrable material. The inlets for air 321 and liquid 322 are shown at the bottom of the nozzle 320.

FIGS. 54 to 56 show further different small nozzles 325, 330 and 335 all have a common fenestration, window or opening 326. The fenestration 326 contains the solid foam or screen material 327. The inlets for air 321 and liquid 322 are shown at the bottom of the nozzles.

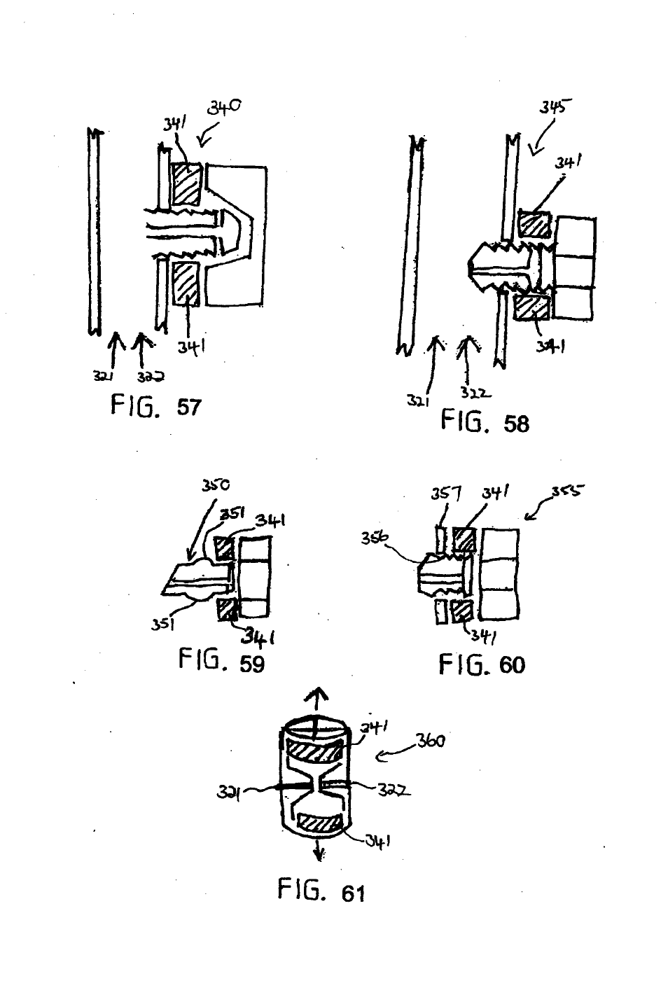

FIGS. 57 and 58 show further small nozzles 340, 345. The nozzles have a screen 341 and inlets for the air 321 and liquid or solution 322.

FIGS. 59 and 60 show two different nozzles 350, 355 which differ only in the way in which the nozzle is mounted. In FIG. 59 a push in type mount is used to secure the nozzle 350 using the wings or raised sections 351 which compress when the nozzle 350 is inserted into the wall of the chamber and expand once through the other side of the wall to securely mount and retain the nozzle 350 in the wall. In FIG. 60 the nozzle 355 has a screw type mount 356 which is screwed into the wall 357 to secure the nozzle 355 in place. Like all of the other small nozzles these two also have a screen 341.

FIG. 61 shows another form of small type nozzle 360. This nozzle 360 is a double sided type nozzle into which air 321 and solution 322 flow and the foam produced by the nozzle 360 exits from either end of the nozzle.

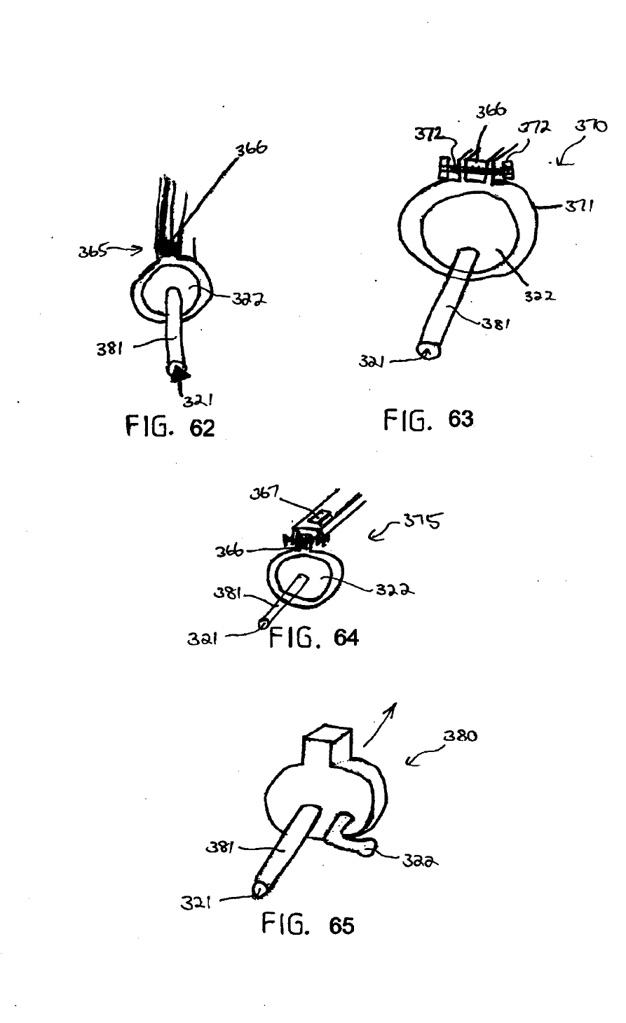

FIGS. 62 to 64 show a further type of nozzle 365, 370 and 375 all of which are longitudinal nozzles. In all of these nozzles air 321 flows in through a tube 381 and the liquid or solution 322 is contained within the outer pipe 371. The screen 366 used in these longitudinal nozzles is secured to the nozzle by screws or clips 372 or any other device which will allow the screen to be secured in place.

In FIG. 64 the longitudinal nozzle 375 also has a fenestration 367.

FIG. 65 shows an end cap 380 which is slid over the tube 381 of the nozzles 365, 370 and 375. The end cap 380 closes of the end of the longitudinal nozzles to which the air 321 and the solution 322 enter.

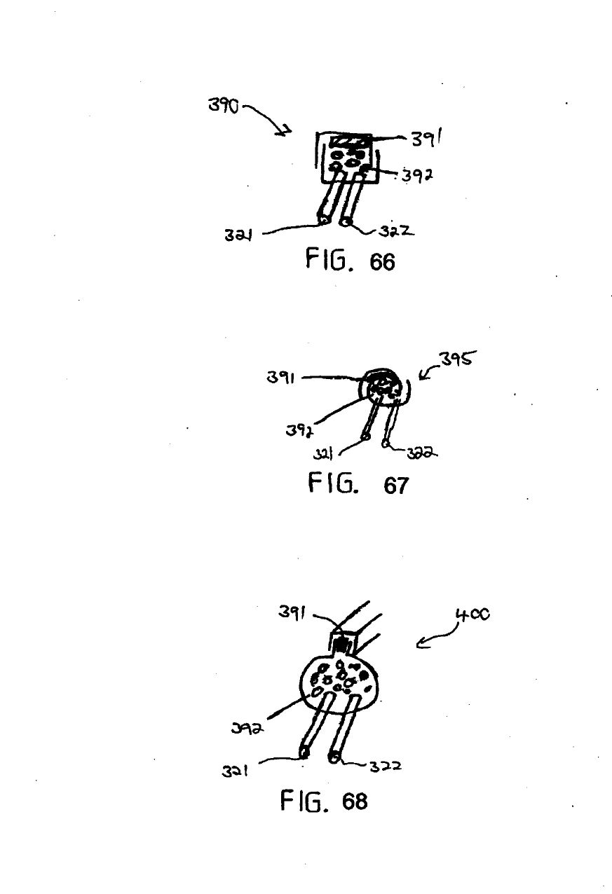

FIGS. 66 to 68 show three types of nozzle 390, 395 and 400 with a vortex type filter 392. The vortex filter 392 is typically a high-speed mechanical filter that is designed to fine filter the foam solution without disturbing the natural bacteria levels. This type of filter 392 is invaluable in keeping a parasite-free, clean, well balanced and healthy foam producing unit. The filter 392 can be any type of volcanic rock, mineral rock, peat moss or any type of carbonised material and may contain a mineraliser or polariser. The mineraliser is used to balance the pH of the foam production units. These filters also contain a screen 391.

The application of any of the above embodiments of the growing units or systems is numerous. For example the growing units may form an integrated system used in a house or apartment. The system could be incorporated into the buildings at the time of the construction when the pipework of air and solution hoses can be built in the walls of the house and different systems could be then placed in different parts of the building by the means of a plug in system similar to that of electrical power points.

These system could be mounted on the walls or be in a form of mobile units. They could be used for growing ornamental plants, vegetables or even trees either domestically in your home or commercially in buildings such as in offices or factories. The system is versatile in that it could be used inside or outside in a number of different situations. For example in the case of the cylindrical systems these could be used for any plants including animal fodder (wheat, grass etc). The added advantage of this form of growing plants is the ability to control the internal growing environment (temperature, humidity and lighting). In a further aspect and to inhibit the temperature control of the systems a cavity on the outside of the cylinder growing system could be used to inject hot air around the outside of the growing cylinder.

In order to provide a foaming or foam solution for growing the plants the liquid or foam solution could be made from many existing solutions by adding a foaming agent (plant or animal protein extract, lipids, starches etc) or any other solution which provides a foam solution or liquid for the growing of plants.

Another advantage derived from growing plants in a liquid foam is the ability to control plant nutrition using the many different types of nozzles and growing systems mentioned above. Typically the nozzles are used mainly in the root chambers or growing containers. The growing containers can be any shape as described above but may also be any shape which allows for the growth and structure of a plant which has not been mentioned previously.

Unlike other growing systems, the use of liquid foam as a nutrient allows for many different opportunities which have not been previously attempted for the known growing systems. For example, the use of liquid foam provides for a light weight and relatively low water content which makes it possible to use vertical systems hanging off the ceilings or suspended horizontally. This system could be used in a form of a visual display in someone's residence or commercial property. A further added advantage of the display style growing unit is that you could also grow your own fruit and vegetables in your own home.

In use these growing units, foam production units and nozzles may be used to provide foam as a nutrient for growing plants. The nozzles in particular may also be used for fire fighting applications as well anywhere which is relatively dry and there exists a need for a fire fighting foam. For example, supplying foam as required in offices, houses or in boat engine rooms where there is a potential fire hazard. The foam production units described above may be used in any configuration depending upon the application. For example, the foam production nozzle of FIGS. 6 and 7 may be mounted at the end of an elongated lance such that the produced foam can be directed to a fire.

Whilst the compartments or chambers which receive the plant roots are usually empty, the compartment or chambers may contain a growing medium such as pebbles or other lightweight material for example coal ash. The pebbles or the like are suitably of different shapes so that roots growing therein can still be exposed to foam supplied to the compartments or chambers. Such an arrangement is particularly suitable for growing of vegetables such as root vegetables.

Foam may be supplied to the root compartments or chambers by any of the foam production units or nozzles as described above. In the case of the embodiment of FIG. 9, the unit 50 may be placed in the bottom of a root chamber for supply of foam to the chamber. For example a unit 50 may be placed at the base of the housing 58 of FIG. 10, at the bottom of a tray 70 of FIGS. 10 and 11 or at the bottom of the compartment 99 of FIG. 23.

Whilst the invention has been described in relation to the production of a liquid foam using air, any other suitable gas maybe used and thus the term “air” as used throughout the specification includes a gas or gases.

The terms “comprising” or “comprises” as used throughout the specification and claims are taken to specify the presence of the stated features, integers and components referred to but not preclude the presence or addition of one or more other feature/s, integer/s, component/s or group thereof.

Whilst the above has been given by way of illustrative embodiment of the invention, all such variations and modifications thereto as would be apparent to persons skilled in the art are deemed to fall within the broad scope and ambit of the invention as herein described.

1. A foam production unit comprising a chamber, inlet means to said chamber for oxygenated air and liquid, and means for controlling the flow of said oxygenated air and liquid through or from said chamber to thereby create a liquid foam.

2. A foam production unit as claimed in claim 1, wherein the chamber of the foam production unit comprises a mixing chamber in which liquid and oxygenated air supplied to the chamber are mixed.

3. A foam production unit as claimed in claim 2, wherein the inlet means comprises one or more inlets for oxygenated air and one or more inlets for liquid, and the chamber has one or more outlets and the means for controlling the flow is provided for controlling or restricting flow from the one or more inlets of oxygenated air and liquid to or through the one or more outlets.

4. (canceled)

5. A foam production unit as claimed in claim 3, wherein the means for controlling flow comprises means in the chamber which provide a controlled directional path for oxygenated air and liquid from the oxygenated air and liquid inlet means to the outlet.

6. A foam production unit as claimed in claim 5, wherein the means for controlling or restricting flow comprises a plurality of discrete elements within the chamber, wherein the discrete elements comprise a plurality of spherical members or members of any other shape, and the discrete elements substantially fill the mixing chamber.

7. (canceled)

8. A foam production unit as claimed in claim 6, wherein the discrete elements only partially fill the chamber, therefore the discrete elements are free for movement in the chamber so as to mix liquid and oxygenated air in the chamber to enhance liquid foam production.

9. A foam production unit as claimed in claim 8, wherein the controlling means within the chamber comprises an organic or other solid permeable material, the permeable material comprises a solid foam, wherein the solid foam is a flexible open cell solid foam such as an organic or other foam.

10. (canceled)

11. A foam production unit as claimed in claim 9, wherein the permeable material is any other organic or inorganic material such as fibrous material which has similar flow controlling or restricting properties to foam.

12. A foam production unit as claimed in claim 3, wherein the one or more outlets from the chamber comprise one or more openings or slots in a wall of the chamber, and are limited such that the oxygenated air and liquid mixed in said chamber can exit from said chamber through the outlet as liquid foam.

13. (canceled)

14. A foam production unit as claimed in claim 12, wherein the one or more outlets comprise a permeable material or member, wherein the permeable material may comprise a solid foam, and the foam is a flexible open cell solid foam such as an organic or other foam.

15. (canceled)

16. A foam production unit as claimed in 14, wherein the permeable material is selectively compressed to vary its permeability and thus the foam production.

17. A foam production unit as claimed in claim 14, wherein the one or more outlets comprise a permeable member or wall for example a member or wall having a plurality of fine perforations.

18. A foam production unit as claimed in claim 2, wherein the mixing chamber is defined by an outer elongated housing or tube, and the at least one oxygenated air supply tube extends into the mixing chamber for supply of oxygenated air thereto, and the at least one liquid supply tube extends into the mixing chamber for supply of liquid thereto.

19. (canceled)

20. (canceled)

21. A foam production unit as claimed in claim 18, wherein the oxygenated air supply tubes and liquid supply tubes are formed so as to allow the directional flow of oxygenated air and/or liquid, wherein the tubes have their side walls perforated.

22. A foam production unit as claimed in claim 21, wherein the outer elongated housing or tube is covered by a layer of permeable material which restricts the passage of liquid and oxygenated air and therefore enhances the production of foam.

23. A foam production unit as claimed in claim 2, wherein the mixing chamber is defined by the annular space between the oxygenated air supply tube and outer housing or chamber and the solution is supplied to the annular space.

24. A foam production unit comprising a nozzle, wherein the nozzle comprises a housing to which liquid and oxygenated air are supplied, the housing having an outlet which is restricted by a solid permeable material, wherein the nozzle controls the flow of said oxygenated air and liquid through or from said foam production unit to thereby create a liquid foam.

25. A foam production unit as claimed in claim 24, wherein the solid permeable material is in the form of a layer of such material.

26. A foam production unit as claimed in claim 25 wherein the permeable material comprises a perforated member.

27. A foam production unit as claimed in claim 26, wherein the foam comprises a foam which contains a plant nutrient or nutrients to promote the growth of plants.

28. (canceled)

29. An apparatus for growing plants as claimed in claim 50, wherein said apparatus comprises a root chamber or compartment for containing the roots of said plants and means for supplying a liquid foam to said root chamber, wherein the liquid foam contains a plant nutrient or nutrients.

30. An apparatus for growing plants as claimed in claim 29, further comprising a foam production unit for forming the liquid foam from a solution of nutrients and a foaming agent, the foaming agent comprises a soluble organic emulsifying concentrated.

31. (canceled)

32. An apparatus for growing plants, the apparatus comprising:
an elongated chamber in the form of a pipe or tube;
a foam production unit extending inside the elongated chamber;
a plurality of spaced openings in the elongated chamber in which plants to be grown are located; and
wherein the foam production unit provides a liquid foam from a solution of nutrients and a foaming agent, wherein the liquid foam containing the nutrients is supplied to the plants to promote the growth of the plants.

33. An apparatus for growing plants as claimed in claim 32, wherein the foam production unit is located externally of the elongated chamber and the liquid foam is fed inside the chamber by a feed tube extending inside the elongated chamber.

34. An apparatus for growing plants as claimed in claim 33, wherein the elongated chamber may be oriented substantially horizontally or oriented substantially vertically.

35. An apparatus for growing plants as claimed in claim 34 wherein when oriented substantially vertically, the elongated chamber may be defined by a plurality of separate compartments, and the foam production unit extends through and be located within the chamber or compartments, the foam production unit is arranged externally with foam the unit supplied to the respective compartments.

36. (canceled)

37. An apparatus for growing plants as claimed in claim 35, wherein the elongated chambers are mounted on a rotatable carousel to be rotatable about a vertical axis.

38. An apparatus for growing plants as claimed in claim 34, wherein the elongated chambers are mounted on a frame for rotation about a horizontal axis.

39. An apparatus for growing plants as claimed in claim 38, wherein the elongated chamber is formed in any shape which allows the growth of plants.

40. An apparatus for growing plants as claimed in claim 39 further comprising
an open topped tray or compartment and
a foam production unit extending through the tray for supply of foam thereto for promoting the growth of plants.

41. An apparatus for growing plants as claimed in claim 40, wherein the trays are mounted on a rotatable frame for movement about a horizontal axis, wherein a pivot means is provided to support the trays to maintain the trays in a substantially horizontal orientation when rotated.

42. An apparatus for growing plants as claimed in claim 41, wherein the foam production unit is provided in the base of the tray or compartment.

43. An apparatus for growing plants comprising:
a foam producing unit having an axis, a peripheral wall extending about said axis and having axially spaced apart opposite ends, and end walls closing said peripheral wall at said opposite ends, said peripheral wall and said end walls providing said foam producing unit with an interior for receiving an oxygenated air and liquid;
a plurality of shaped projections extending outwardly from the peripheral wall of the foam production unit;
a root chamber comprising a top wall, a bottom wall and side walls enclosing the root chamber and spaced apart end walls, at least one end wall having a complimentary shaped projection to receive the shaped projection extending from the peripheral wall of the foam production unit, said top wall having an opening for receiving a plant; and
a means for controlling the flow of said oxygenated air and liquid through or from said foam producing unit and into said root chamber to thereby create a liquid foam which contains a plant nutrient or nutrients to promote the growth of plants.

44. An apparatus for growing plants as claimed in claim 43, wherein the peripheral wall of said foam producing unit is formed in the shape of a polygon.

45. An apparatus for growing plants as claimed in claim 43, wherein the peripheral wall of said foam producing unit is formed in the shape of a cylinder.

46. An apparatus for growing plants as claimed in claim 43, wherein the shaped projections extending from the peripheral wall are either in the shape of a polygon or a cylinder.

47. An apparatus for growing plants as claimed in claim 46, wherein the foam production unit further comprises projections extending outwardly from said end walls to receive said oxygenated gas and liquid, and said projections are used to mount said apparatus for growing plants in a vertical arrangement.

48. (canceled)

49. An apparatus for growing plants as claimed in claim 47, wherein said projections are mounted into a carousel for rotating the growing apparatus.

50. An apparatus for growing plants as claimed in claim 49, further comprising at least one reflector mounted to an edge of side of said growing apparatus to reflect light to promote the growth of the plants, and at least one light source to promote the growth of plants.

51. (canceled)

52. A foam production and unit as claimed in claim 27 also used for producing foam for fire suppression applications or any other applications where liquid foam is required.

53. A foam production unit as claimed in claim 52, wherein the liquid foam comprises a fire suppressant liquid.
